(19) United States
(12) Patent Application Publication
(10) Pub. No.: US 2004/0112991 A1
(43) Pub. Date: Jun. 17, 2004

(54) Hydrotherapy massaging device

(76) Inventor: Wilbert E. Rojewski, Hollister, CA (US)

Correspondence Address: MORGAN, LEWIS & BOCKIUS, LLP., 3300 HILLVIEW AVENUE, PALO ALTO, CA, 94304, US

(21) Appl. No.: 10/299,871

(22) Filed: Nov. 18, 2002

(51) Int. Cl. B05B 1/14

(52) U.S. Cl. 239/548

(57) ABSTRACT

The present invention provides a device for dispersing a fluid into a body of liquid, comprising a body having an outer surface that comprises a top surface and configured to be disposed within a container for holding a liquid, wherein the body defines a plurality of fluidly-connected and embedded channels, each fluidly connected to a separate perforation on the top surface, and an opening in the outer surface fluidly connected to at least one of the plurality of fluidly-connected and embedded channels and configured to receive and pass a fluid to the at least one of the plurality of fluidly-connected and embedded channels. A method for utilizing the same is also described.

### BACKGROUND OF THE INVENTION

1. Field of the Invention

The invention relates generally to a hydrotherapy massaging device. More particularly, the invention is directed to a hydrotherapy massaging device that disperses a fluid into a body of liquid.

2. Description of Related Art

Hydrotherapy, a therapy treatment using water, is beneficial for the treatment of a variety of ailments including muscle tension, soreness, swelling, relief from pain and promotion of healing. Hydrotherapy's beneficial effects have also been touted to arise from the enjoyment and pleasure of the treatment itself. The simplest form of hydrotherapy involves merely immersing a body part in water.

Typically, hydrotherapy is accomplished in a large liquid-filled container that has at least a pump for circulation of the liquid, a heating system for heating the liquid, a filtering system, and related equipment. Examples of this type of apparatus include bath tubs, spas and swimming pools. These large hydrotherapy apparatuses require continual maintenance and upkeep and are costly to operate. Furthermore, these units tend to be large, expansive and difficult to move to another location.

Attempts have been made to address these limitations, and, as a result, “portable spas” were developed. Still, these spas were not truly portable but rather developed as modules that could be separated and moved as opposed to one self-contained unit. This modular construction facilitated the portability of the spa, but, nevertheless, spas of this nature are not designed for daily movement.

Since spas of all types remain costly and are cumbersome to move, truly portable spa units have been developed. These portable units are designed to treat specific, localized areas. An example of this type of unit is a foot massaging unit as described in U.S. Pat. No. 5,729,841 to Chan, which is hereby incorporated by referenced in its entirety. Units of this nature combine portability with convenience, low cost, self-containment, and simplistic elements that do not require constant upkeep or maintenance. Furthermore, portable units offer a variety of hydrotherapy treatments including massage, hot water therapy, and means for generating bubbles to create a spa-like effect. While these portable units address many problems associated with conventional spas, nevertheless, these devices are designed for treatment of only a specified extremity and only in the manner in which the unit is constructed. Therefore, these units provide little flexibility in customizing treatment. In addition, in order to keep these units cost effective, the units are economically constructed and are not designed to withstand heavy-duty use.

While hydrotherapy treatment using conventional large liquid-filled containers are easily adaptable for use with animals, the portable units are not. As previously explained, these units are not designed to withstand the more demanding use of animals. In particular, portable units are not adaptable for use with large ungulates such as horses.

As a result, alternative portable hydrotherapy treatment methods were designed for ungulates so that treatment could be afforded away from the stable setting. These treatments include cold/ice therapy, heat therapy, massage therapy, and hydrotherapy.

The cold/ice therapies include such treatment as cold water hosing, ice wraps, and cold water therapy. Cold therapies reduce swelling and inflammation in damaged tissues, and, when used immediately following an injury, constrict the blood vessels to slow hemorrhage. However, the ice wraps and cold water therapy provide only very localized treatment, and the cold water hosing may actually worsen the condition if the water pressure is too high.

For some types of injuries, warm moist heat or heat therapy is used to increase blood flow to the affected area and to speed healing. As with the cold therapy, the treatment is localized to the point of application. Massage therapy increases lymphatic and blood circulation. This type of therapy requires the handler to exert direct pressure around the injured area. However, the direct pressure applied to an injured site may cause further injury and discomfort to the animal.

Due to the limitations of the above treatment methods, hydrotherapy is a preferable treatment method for sprains, muscles exertions, swelling and the like, particularly for ungulates. Currently, hydrotherapy treatment methods are limited to either large liquid-filled containers or shower-like enclosures, which pose the problems explained earlier, and hose therapy units. Hose therapy units provide treatment by affixing bands to an affected area of a leg for example and then attaching a hose to the unit. The hose can be connected to either warm or cold water. The water flows through the hose to the bands and then onto the leg where the band is attached. These types of units address the concerns regarding regulating pressure and minimizing injury as result thereof. However, the water that flows onto the leg then flows to the ground and must be directed out of the treatment area.

In light of the above, there is a need for an apparatus for hydro-therapeutic treatment of ungulates that is portable, durable and cost efficient. Furthermore, there is a need for a device that can be adapted for use with a variety of hydrotherapy treatment elements.

### BRIEF SUMMARY OF THE INVENTION

In one embodiment, the present invention is a device for dispersing a fluid into a body of liquid, comprising a body having an outer surface that comprises a top surface and configured to be disposed within a container for holding a liquid, wherein the body defines a plurality of fluidly-connected and embedded channels, each fluidly connected to a separate perforation on the top surface, and an opening in the outer surface fluidly connected to at least one of the plurality of fluidly-connected and embedded channels and configured to receive and pass a fluid to the at least one of the plurality of fluidly-connected and embedded channels.

In another embodiment, the present invention is a device for dispersing a fluid into a body of liquid, comprising a ring-shaped body having and outer surface comprising an inner side surface and configured to be disposed within a container for holding a liquid, wherein the body defines an embedded, substantially circular channel, an opening in the outer surface fluidly connected to the embedded, approximately circular channel and configured to receive a fluid, and a plurality of perforations on the inner side surface fluidly connected to the embedded, approximately circular channel.

In yet another embodiment, the present invention is a device for dispersing a fluid into a body of liquid, comprising a body having a substantially flat bottom base and an outer surface comprising a top surface that defines a depression in the body, the depression having a surrounding wall comprising an upper portion having an upper portion perimeter and a lower portion and configured for receipt of a container, wherein the body defines a outer surface opening, the upper portion is configured to seal against the container along the upper portion perimeter, and the lower portion is configured to define, in conjunction with a portion of the container, an embedded cavity and a lower portion opening fluidly connected to the outer surface opening for passing a fluid from the outer surface opening to the embedded cavity.

The present invention also provides a method for massaging, comprising placing an injured bodily area within a liquid in a container and pumping a fluid through a fluid dispersion body disposed within the container below the injured bodily area, wherein the fluid dispersion body has an outer surface that comprises a top surface and defines a plurality of fluidly-connected and embedded channels, each fluidly connected to a separate perforation on the top surface, and an opening in the outer surface fluidly connected to at least one of the plurality of fluidly-connected and embedded channels and configured to receive and pass the fluid to the at least one of the plurality of fluidly-connected and embedded channels.

The present invention provides a durable and portable device for creating a spa-like or massaging effect in a container such as a bucket. In particular, the present invention provides such a device that is easily adapted for therapeutic use with ungulates, such as the leg or ankle of a horse. Addition embodiments and advantages of the present invention will be evident from the following drawings and description.

### BRIEF DESCRIPTION OF THE DRAWINGS

FIG. 1 is a side view of a hydrotherapy device in accordance with one embodiment of the present invention;

FIG. 2 is a top cross-sectional view of the hydrotherapy device of FIG. 1 taken along the line A-A of FIG. 1;

FIG. 3 is a cross-sectional view of the hydrotherapy device of FIG. 1 taken along the line B-B of FIG. 2;

FIG. 4 is a top view of the hydrotherapy device of FIG. 1;

FIG. 5 is a side view of a container for use with the hydrotherapy device of FIG. 1;

FIG. 6 is a top view of a hydrotherapy device in accordance with another embodiment of the present invention;

FIG. 7 is a perspective view of the hydrotherapy device of FIG. 6 taken along the line A-A of FIG. 6;

FIG. 8 is a side view of a container for use with the hydrotherapy device of FIG. 6;

FIG. 9 is a perspective view of a hydrotherapy device in accordance with yet another embodiment of the present invention;

FIG. 10 is a perspective view of the hydrotherapy device of FIG. 9 taken along the line A-A of FIG. 9;

FIG. 11 is a side view of a container for use with the hydrotherapy device of FIG. 9;

FIG. 12 is a cross-sectional view of a hydrotherapy device according to another embodiment of the present invention; and

FIG. 13 is a side view of a container for use with the hydrotherapy device of FIG. 12.

### DETAILED DESCRIPTION OF THE INVENTION

The present invention is best understood by reference to the drawings in which like reference numerals refer to like parts and to the following description. However, it should be appreciated that the following description is intended to be exemplary only and not limiting. For example, while the terminology used refers to hydrotherapy, nothing in the present invention is intended to limit the use of the invention to those uses calling for water, and, therefore, the invention is equally applicable to use with other liquids or solutions, such as salt solutions. It should also be appreciated that the term “fluid” is used to refer to either a gas or a liquid.

In its broadest sense, the present invention is a device for dispersing a fluid, either a gas or a liquid, into a container holding a liquid, such as water. The dispersion of a gas into the liquid in the container produces bubbles in the liquid and a hydrotherapy massaging effect. Alternatively, the dispersion of a liquid into the liquid in the container also produces a therapeutic massaging effect. In either case, the device for dispersing the fluid is referred to below as a hydrotherapy device; however, such terminology, as noted above, should not be construed as limiting.

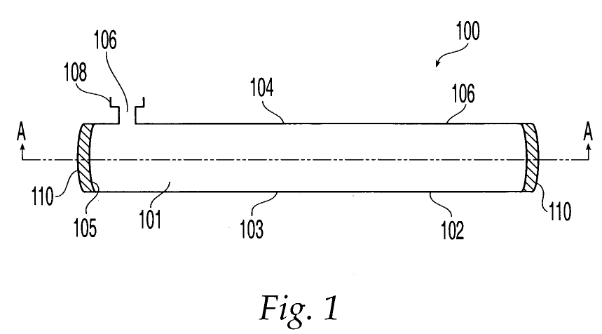

FIGS. 1-4 illustrate one preferred embodiment of the present invention. FIG. 1 is a side view of a hydrotherapy device 100 in accordance with one embodiment of the present invention. The hydrotherapy device 100 comprises a body 101. The body 101 is a cylindrical body and is designed to fit into the bottom of a container, such as a bucket, that is capable of holding a liquid such as water. Therefore, the height of the body 101, or the height of the wall 105, is preferably relatively short compared to the height of the container or liquid level that will be used in that container. Preferably the height of the body 101 is approximately 1/2 inch. It should be appreciated, however, that the body may be any pre-determined shape. Preferably, however, the pre-determined shape of the body is one that conforms to the inside shape of the container into which it will be placed, thereby providing a friction-fit or snug fit between the body of the hydrotherapy device and the container. Such a fit would reduce any movement of the body during use. More preferably, the shape of the body is circular so that an ordinary bucket maybe used as the container.

The body is preferably made from a material that provides durability and flexibility, such as a molded plastic, such as urethane. It should be appreciated, however, that the body may be constructed by any means known in the art. For example, the body may be molded and made as one integral piece or it may be made of several pieces, such as a top half and a bottom half.

The body 101 comprises an outer surface 102, which is understood to mean the entire outer surface of the body 101. The outer surface 102 comprises a lower surface 103 and a top surface 104. The body 101 further comprises a wall 105 that extends from the top surface 104 to the lower surface 103. The body 101 further comprises an opening 106, which may be located any where on the outer surface 102 but that is preferably disposed on the top surface 104. As shown, attached to the opening 106 is a connector 108 for receiving a hose or tube or line (not shown) through which a fluid may be passed to the device 100. For example, such a hose can be attached to an air compressing device or the outlet of a liquid pump. The connector 108 may be a flexible connector such that it may be moved or oriented as necessary to mate with a hose at any angle. Optionally, a gasket 110 may be used to surround the hydrotherapy device 100.

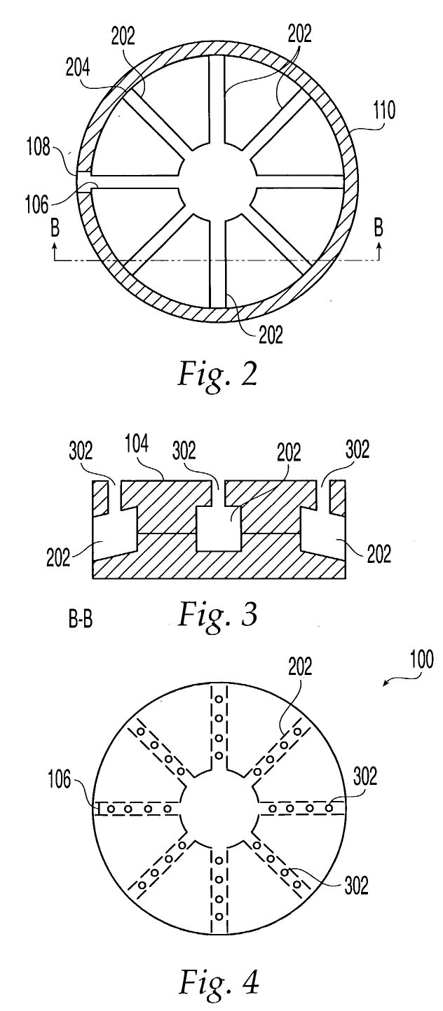

FIG. 2 is a top cross-sectional view of the hydrotherapy device of FIG. 1 taken along line A-A of FIG. 1. The hydrotherapy device 100 comprises a plurality of fluidly-connected and embedded channels 202, which preferably are arranged such that each of the channels 202 extends in a radial direction from the center of the body 101 towards its perimeter. In addition, it is preferable that each of the channels 202 extend in a direction substantially parallel to the bottom surface 103 and the top surface 104 of the body 101 so that the channels 202 may be embedded or enclosed within the body 101. In other words, the channels 202 are located within the body 101 and are substantially encased on both their top and bottom and at one end, preferably the distal end 204, as it is easier to make the proximate end 206 open and in fluid communication with the other channels 202. It should be appreciated, however, that each of the channels are not entirely sealed-or liquid-tight, as at least one channel 202 is fluidly connected to the opening 106 and because, as described below in connected with FIGS. 3 and 4, each of the channels has a plurality of perforations extending from the channel through the body to the top surface. It should be appreciated that the opening 106 extends from the top surface 104 through the body to one of the channels 202. In other words, the opening 106 is fluidly connected to at least one of the channels 202 such that a fluid may be passed through the opening 106 and into one of the channels 202. Since each of the channels 202 is connected, this fluid will then pass through each of the channels 202.

Generally, it should be appreciated that the channels may be arranged in any pattern, and the number of channels may vary as well. Moreover, the geometry of the cross-section of the channels may also vary from square to circular to any other shape. Further, the channels need not be straight and can follow any path within the body. For example, each channel may be any curved shape to allow the plurality of perforations discussed in connection with FIGS. 3 and 4 to be located at any point on the top surface of the body. The geometry depicted herein is not intended to be a limitation on the present invention.

FIG. 3 is a cross-sectional view of the hydrotherapy device of FIG. 1 taken along line B-B of FIG. 2. In this view, several of the fluidly-connected channels 202 are shown. Each channel 202 has at least one, but preferably a plurality of, separate perforations 302 that extend from the channel 202 through the body 101 to the top surface 104. In FIG. 3, however, just one such perforation 302 is shown for each channel 202.

FIG. 4 is a top view of the hydrotherapy device of FIG. 1. As shown, each channel 202 has a plurality of fluidly-connected perforations 302. As the fluid is passed from the opening 106 through each of the channels 202, it will then pass through the perforations 302 and into the liquid in the container. It should be appreciated that the size and shape of the perforations may vary to provide various therapeutic effects, and the embodiment pictured herein is provided for illustrative purposes only. Therefore, one of skill in the art will appreciate that the number of channels, and their size and shape, and the number of perforations, and their size and shape, may be designed to provide a wide range of bubble sizes and rates of bubble flow when the fluid passed through the channels is a gas, such as air. Similarly, these same parameters may be utilized to provide a wide range of flow patterns coming from the perforations with the fluid passed through the channels is a liquid such as warm water.

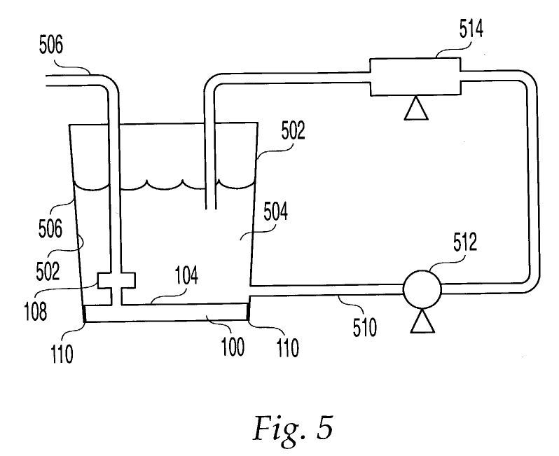

FIG. 5 is a side view of a container for use with the hydrotherapy device of FIG. 1. The hydrotherapy device 100 rests on the bottom of the container 502 such that it is sealed against the inner surface of the container by the gasket 110, which acts to hold the hydrotherapy device 100 in place. The container holds a liquid 504, which may be water or any other liquid that is to be therapeutically used, such as a salt solution. The connector 108 is shown extending upward from the upper surface 104 as depicted in FIG. 1. A hose 506 is attached to the connector 108 to allow a fluid, such as air or water, to pass to the channels 202 of the hydrotherapy device 100. One skilled in the art will also appreciate that a hole could be drilled through the side of the container 502. In this embodiment, the opening 106 would be positioned on the side of the hydrotherapy device 100. Further, in this embodiment, a gasket would be required to seal the hole in the container around the hose.

During operation, the hydrotherapy device 100 is placed inside the container 502. The container 502 is then filled with a liquid 504, typically water, noting that the container may be filled first before placing the hydrotherapy device 100 in the container. The hose 506 is then attached to both the connector 108 and to a fluid pump (not shown), such as an air pump in the case where the fluid is a gas or an ordinary liquid pump in the case where the fluid is a liquid such as water. The fluid is then pumped through the hose 506 to the channels 202 and exits through the perforations 302 to provide bubbles in the liquid 504 in the case where the fluid is a gas or a massaging liquid flow in the case where the fluid is a liquid. An injured body area, such as the ankle of an ungulate, may then be placed in the container and exposed to the spa-like therapy. It should be appreciated that the order of the foregoing steps may be altered to accommodate the specific situation and should not be viewed as limiting.

Referring back to FIG. 5, it should be appreciated that a recirculation line 510 may also be utilized to recirculate the liquid in the container through a heater to maintain a pre-determined temperature in the container. A liquid pump 512 may be used to pump the liquid 504 in the container 502 through a heater 514 and back to the container 502. It should be appreciated that the liquid pump could be utilized to pump water from either the top of the container or bottom. In the case where the liquid is removed from the top of the container and pumped back into the container near the bottom, but above the hydrotherapy device 100, such would provide additional massaging effects. It should be appreciated that any heater capable of heating a liquid flowing through a line, tube or pipe may be used. Moreover, heating of the liquid in the container may be accomplished in a variety of manners such as the application of an external heat source surrounding the container, the insertion of a heating element in the container, or the pumping of warm fluid into the container through the hydrotherapy device 100 itself. Further, any control mechanism may be used to operate this recirculation line and maintain the temperature of the liquid in the container at the desired value. It should be appreciated that while FIG. 5 is discussed in terms of the use of a heater, it may be desirable to utilize cool or colder water as the fluid that is recirculated. In this case, the heater may be replaced with a device for cooling the liquid, such as a cold bath or a heat exchanger that utilizes a cooling fluid.

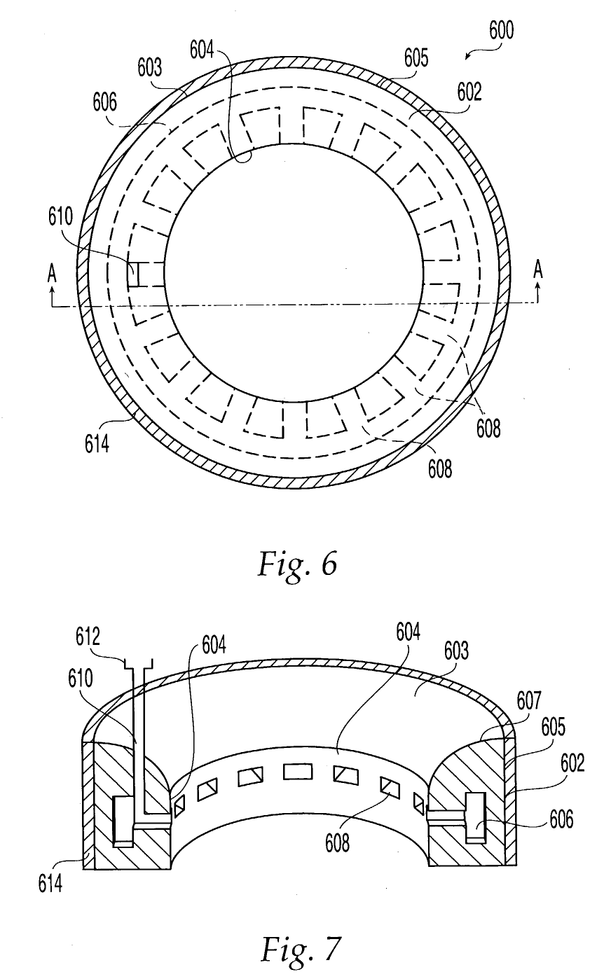

FIGS. 6-8 illustrate a hydrotherapy device according to another embodiment of the present invention. FIG. 6 is a top view of a hydrotherapy device in accordance with another embodiment of the present invention, and FIG. 7 is a perspective view of the hydrotherapy device of FIG. 6 taken along line B-B of FIG. 6. For the following discussion, reference should be made to both FIGS. 6 and 7.

The hydrotherapy device 600 has a body 602 that is ring-shaped and has an outer surface 603, which is understood to mean the entire outer surface of the body 602. The outer surface 603 has an inner side surface 604, an outer side surface 605, and a top surface 607. The body 602 is designed to fit into the bottom of a container, such as a bucket, that is capable of holding a liquid such as water. The inner and outer diameters of the body 602 may be varied depending upon the size of the container into which the device 600 is placed. Preferably, the outer diameter is such that the body 602 conforms to the inside of the container into which it is placed. The overall height of the body 602 may vary but is preferably relatively short compared to the height of the container or liquid level that will be used in that container. Optionally, a gasket 614 may be used to surrounding the hydrotherapy device 600.

In a preferred embodiment, the height at the outer side surface 605 of the body 602 is greater than the height at the inner side surface 604. More preferably the top surface 607 is sloped downward from the outer side surface 605 to the inner side surface 604 so that insertion of an injured bodily area, such as the foot of an ungulate, is more easily accommodated, since it will easily slide into the center of the container and body 602.

The body is preferably made from a material that provides durability and flexibility, such as a molded plastic, such as urethane. It should be appreciated, however, that the body may be constructed by any means known in the art. For example, the body may be molded and made as one integral piece or it may be made of several pieces, such as a top half and a bottom half.

Also shown is an embedded, substantially circular channel 606 that traverses the entire ring of the body 602. It should be appreciated that the cross-section of the channel 606 may be any shape, such as rectangular or circular. The channel 606 is fluidly connected to a plurality of perforations 608 that extend from the channel 606 through the inner side surface 604. It should be appreciated that the perforations 608 may be placed any where on the inner side surface 604, such as along both the circumference and height of the inner side surface 604, and need not be placed in a set pattern or at a set height along inner side surface 604. Preferably, the perforations 608 are positioned in conjunction with the overall height of the body 602 such that the fluid dispersed from the body 602 is aligned with the injured bodily area receiving treatment, for example, the ankle or leg of the ungulate.

Alternatively, vertical placement of the hydrotherapy device 600 in the container may be varied to ensure that the fluid exiting the perforations 608 impacts the injured body part, such as at the appropriate height of an ungulate's leg where the injury is located. The hydrotherapy device 600 may thus be secured at any height in the container. For example, the body 602 may be sized to provide a friction-fit at a pre-determined height against a bucket wall rather than simply being positioned on the bottom of the bucket. The example of the hydrotherapy device 600 described herein is not limiting in any way on the geometry of the hydrotherapy device 600 and is provided for illustrative purposes only. The heights and lengths of the surfaces and walls may vary to accommodate different geometries.

Similarly, the thickness of the body 602, which is the distance between the outer side surface 605 and the inner side surface 604, is preferably dimensioned to provide optimum impact from the fluid exiting the perforations 608 and to minimize movement of, for example, an ungulate's leg while still allowing the hoof to easily pass through the center of the body 602.

An opening 610 is positioned on the outer surface 603 and is fluidly connected to the channel 606. The opening 610 may be located any where on the outer surface 603. It should be appreciated that the opening 610 extends from the outer surface 603 through the body 602 to the channel 606. In other words, the opening 610 is fluidly connected to the channel 606 such that a fluid may be passed through the opening 610, into the channel 606 and through the perforations 608.

As shown, attached to the opening 610 is a connector 612 for receiving a hose or tube or line (not shown) through which a fluid may be passed to the device 600. For example, such a hose can be attached to an air compressing device or the outlet of a liquid pump. The connector 612 may be a flexible connector such that it may be moved or oriented as necessary to mate with a hose at any angle.

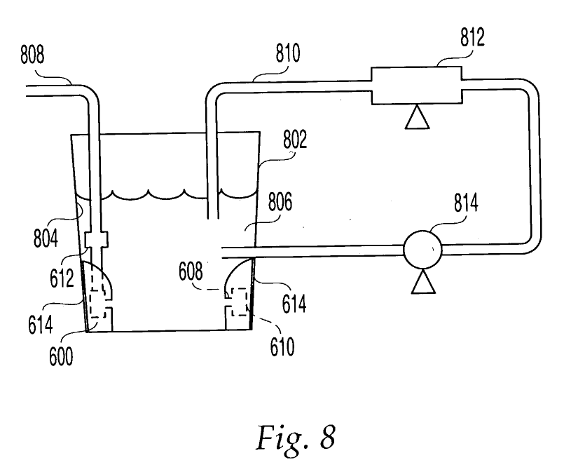

FIG. 8 is a side view of a container 802 for use with the hydrotherapy device of FIG. 6. The hydrotherapy device 600 rests on the bottom of the container 802 and is sealed against the inner surface 804 of the container 802 with a gasket 614. It should be appreciated that the gasket 614 is optional but, if used, it may be of any size or shape that provides a friction-fit between the device 600 and the container 802. The container 802 is filled a liquid 806, which may be water or any other liquid that is to be therapeutically used, such as a salt solution. The connector 612 is shown as extending upward from the upper surface 603 as depicted in FIG. 7. A hose 808 is attached to the connector 612 to allow a fluid, such as air or water, to pass to the channel 606. One skilled in the art will also appreciate that a hole could be drilled through the side of the container 802. In this embodiment, the opening 610 would be positioned on the outer side surface 605 of the hydrotherapy device 600. Further, in this embodiment, a gasket would be required to seal the hole in the container around the hose.

During operation, the hydrotherapy device 600 is placed inside the container 802. The container 802 is then filled with a liquid 806, typically water, noting that the container may be filled first before placing the hydrotherapy device 600 in the container. The hose 808 is then attached to both the connector 612 and to a fluid pump (not shown), such as an air pump in the case where the fluid is a gas or an ordinary liquid pump in the case where the fluid is a liquid such as water. The fluid is then pumped through the hose 808 to the channel 610 and exits through the perforations 608 to provide bubbles in the liquid 806 in the case where the fluid is a gas or a massaging liquid flow in the case where the fluid is a liquid. An injured bodily area, such as the ankle of an ungulate, may then be placed in the container and exposed to the spa-like therapy. It should be appreciated that the order of the foregoing steps may be altered to accommodate the specific situation and should not be viewed as limiting.

Referring back to FIG. 8, it should be appreciated that a recirculation line 810 may also be utilized to recirculate the liquid in the container through a heater to maintain a pre-determined temperature in the container. A liquid pump 814 may be used to pump the liquid 806 in the container 802 through a heater 812 and back to the container 802. It should be appreciated that the liquid pump could be utilized to pump water from either the top of the container or bottom. In the case where the liquid is removed from the top of the container and pumped back into the container near the bottom, but above the hydrotherapy device 100, such would provide additional massaging effects. It should be appreciated that any heater capable of heating a liquid flowing through a line, tube or pipe may be used. Moreover, heating of the liquid in the container may be accomplished in a variety of manners such as the application of an external heat source surrounding the container, the insertion of a heating element in the container, or the pumping of warm fluid into the container through the hydrotherapy device 600 itself. Further, any control mechanism may be used to operate this recirculation line and maintain the temperature of the liquid in the container at the desired value. It should be appreciated that while FIG. 8 is discussed in terms of the use of a heater, it may be desirable to utilize cool or colder water as the fluid that is recirculated. In this case, the heater may be replaced with a device for cooling the liquid, such as a cold bath or a heat exchanger that utilizes a cooling fluid.

One skilled in the art will realize that hydrotherapy device 100 and hydrotherapy device 600 are designed to allow maximum portability and flexibility of use. However, either may be permanently bonded in a bucket or other container. While portability is an important aspect of both the hydrotherapy device 100 and the hydrotherapy device 600, such feature is not intended to be a limitation on the present invention.

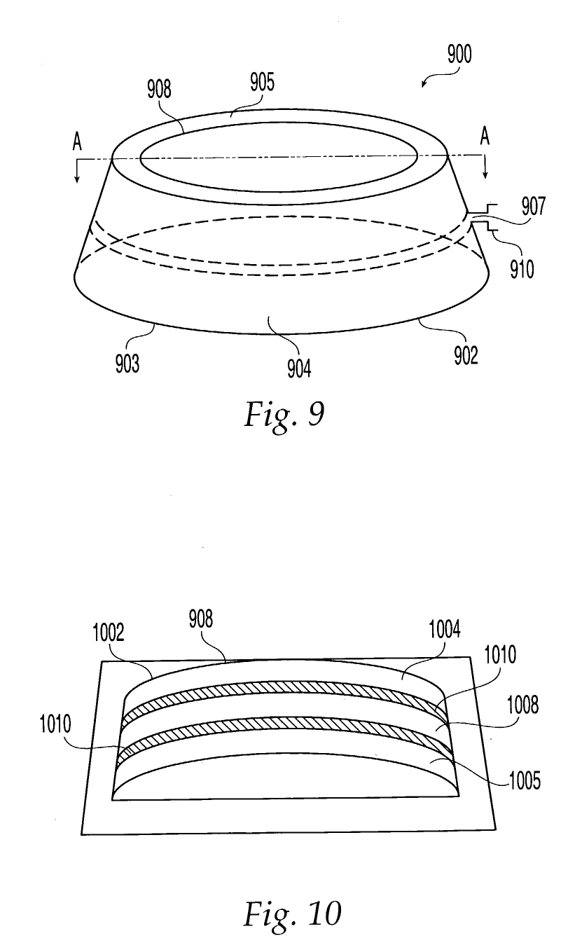

FIGS. 9-11 illustrate a hydrotherapy device according to yet another embodiment of the present invention. FIG. 9 is a side view of a hydrotherapy device 900 in accordance with another embodiment of the present invention, and FIG. 10 is a cross-section view of the hydrotherapy device of FIG. 9 taken along the line A-A of FIG. 9. For the following discussion, reference should be made to both FIGS. 9 and 10.

Hydrotherapy device 900 comprises a body 902 that has a substantially flat bottom base 903, a outer surface 904, which is construed to mean the entire outer surface of the body 902, and a top surface 905. The top surface 905 defines a depression 906, or cavity, in the body 902 for receipt of a container that holds a liquid such as water. The depression 906 is defined by a surrounding wall 1002 and may generally take any shape. Preferably, the shape of the surrounding wall 1002 conforms to the exterior shape of the container, which is to be inserted into the depression 906, such as a cylindrical shape to permit receipt of a bucket as the container.

The surrounding wall 1002 comprises an upper portion 1004 and a lower portion 1005. The upper portion 1004 also has a upper portion perimeter 908 that defines the top or opening of the depression 906. The lower portion 1005 of the surrounding wall 1002 has a cavity or channel 1008 that extends about the surrounding wall 1002. The channel 1008 may be any shape but preferably is a semi-circular channel in the face of the surrounding wall 1002. Upon insertion of a container into the depression 906, the wall of the container will act to enclose the channel 1002. Optionally, gaskets 1010 may be placed above and below the channel 1008 such that upon insertion of a container into the depression 906, the gaskets forms a liquid-tight seal against the side of the container.

The body 902 further comprises an opening 907, which may be located any where on the outer surface 904. However, the opening 907 is fluidly connected to the channel 1008. In one embodiment, the opening 907 is adjacent to the channel 1008 as shown in FIG. 9. As shown, attached to the opening 907 is a connector 910 for receiving a hose or tube or line (not shown) through which a fluid may be passed to the device 900. For example, such a hose can be attached to an air compressing device or the outlet of a liquid pump. The connector 910 may be a flexible connector such that it may be moved or oriented as necessary to mate with a hose at any angle.

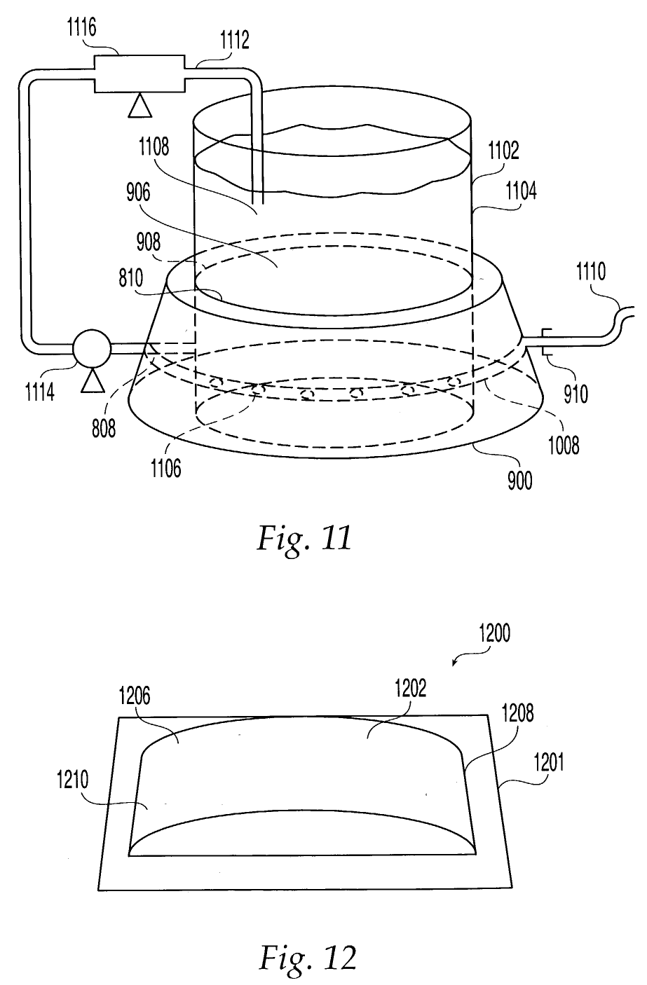

FIG. 11 is a side view of a container for use with the hydrotherapy device of FIG. 9. The container 1102 is placed inside the hydrotherapy device 900 such that preferably the wall 1104 of the container 1102 fits snugly into the depression 906, thereby providing a liquid-tight seal around the container at least at some point within the upper portion 1104 of the surrounding wall 1102 of the depression 906. With such a liquid-tight seal, the gaskets 1010 may not be needed. It should be appreciated, however, that a liquid-tight seal is necessary around the channel 1008. As shown, the container 1102 has perforations 1106 disposed about its perimeter that align with the channel 1108 when the container is within the depression 906. It should be appreciated that the perforations 1106 may be any size or shape. The container 1102 also contains a liquid 1006, such as water. Also, a hose 1110 is connected to the connector 910 for passing a fluid, either a gas or a liquid to the opening 906 and through to the channel 1008.

During operation, the container 1102 is placed inside of the depression 906 of the hydrotherapy device 900. The container 1102 is then filled with a liquid 1108, typically water, noting that the container may be filled first before placing it in the device 900. The hose 1110 is then attached to both the connector 910 and to a fluid pump (not shown), such as an air pump in the case where the fluid is a gas or an ordinary liquid pump in the case where the fluid is a liquid such as water. The fluid is then pumped through the hose 1110 to the channel 1008 and exits through the perforations 1106 in the container 1102 to provide bubbles in the liquid 1108 in the case where the fluid is a gas or a massaging liquid flow in the case where the fluid is a liquid. Thereafter, an injured bodily area, such as the ankle of an ungulate, is placed in the container and exposed to the spa-like therapy.

Referring back to FIG. 11, it should be appreciated that a recirculation line 1112 may also be utilized to recirculate the liquid in the container through a heater to maintain a pre-determined temperature in the container. A liquid pump 1114 may be used to pump the liquid 1108 in the container 1102 through a heater 1116 and back to the container 1102. It should be appreciated that the liquid pump could be utilized to pump water from either the top of the container or bottom. In the case where the liquid is removed from the top of the container and pumped back into the container through the channel 1008 and the perforations 1106, additional massaging effects would be provided. It should be appreciated that any heater capable of heating a liquid flowing through a line, tube or pipe may be used. Moreover, heating of the liquid in the container may be accomplished in a variety of manners such as the application of an external heat source surrounding the container, the insertion of a heating element in the container, or the pumping of warm fluid into the container through the hydrotherapy device 900 itself. Further, any control mechanism may be used to operate this recirculation line and maintain the temperature of the liquid in the container at the desired value. It should be appreciated that while FIG. 11 is discussed in terms of the use of a heater, it may be desirable to utilize cool or colder water as the fluid that is recirculated. In this case, the heater may be replaced with a device for cooling the liquid, such as a cold bath or a heat exchanger that utilizes a cooling fluid.

In yet another embodiment of the present invention, the hydrotherapy device 900 may be constructed without a base such that the body 902 would essentially be in the shape of a sleeve that fits around the container. As described in connection with FIGS. 9-11, the cavity or channel 1008 would still need to be sealed against the wall of the container about which the sleeve was disposed. Otherwise, all of the features and operation of the hydrotherapy device 900 would be the same.

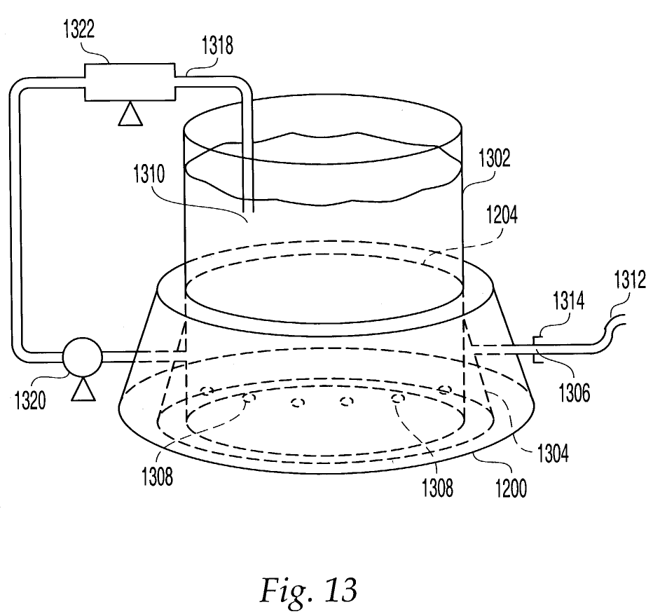

FIG. 12 is a cross-section view of a hydrotherapy device according to another embodiment of the present invention. FIG. 13 is a side view of a container 1302 for use with the hydrotherapy device 1200 of FIG. 12. FIGS. 12 and 13 are similar to FIGS. 10 and 11 except that the shape of the depression is different and a channel or cavity in the surrounding wall is not needed. In this embodiment, the shape of the depression 1202 is a frustrum of a right circular cone. Turning to FIG. 13, upon insertion of a container 1302 into the depression 1202, the upper portion 1206 of the surrounding wall 1208 seals against the container 1302, thereby forming a liquid-tight seal. As a result of the shape of the depression 1202, and, in particular, the sealing of the upper portion 1206 of the surrounding wall 1208 of the depression 1202, a cavity 1304 is form in the lower portion 1210. The body 1201 also has an opening 1306 that extends from the outer surface of the body 1201 through to the cavity 1304. As shown, the container 1302 contains a liquid 1310 and must have perforations 1308 disposed about its perimeter that are at least below the upper portion 1206 so that a fluid introduced into the cavity 1304 will pass through the perforations 1308 and into the liquid 1310. It should be appreciated that the perforations 1308 may be any size or shape. Also, a hose 1312 is connected to a connector 1314 that is attached to the opening 1306 for passing a fluid, either a gas or a liquid to the opening 1306 and through to the cavity 1304.

During operation, the container 1302 is placed inside of the depression 1202 of the hydrotherapy device 1200. The container 1302 is then filled with a liquid 1310, typically water, noting that the container may be filled first before placing it in the device 1200. The hose 1316 is then attached to both the connector 1314 and to a fluid pump (not shown), such as an air pump in the case where the fluid is a gas or an ordinary liquid pump in the case where the fluid is a liquid such as water. The fluid is then pumped through the hose 1316 to the cavity 1304 and exits through the perforations 1308 in the container 1302 to provide bubbles in the liquid 1310 in the case where the fluid is a gas or a massaging liquid flow in the case where the fluid is a liquid. Thereafter, an injured bodily area, such as the ankle of an ungulate, is placed in the container and exposed to the spa-like therapy. It should be appreciated that the order of the foregoing steps may be altered to accommodate the specific situation and should not be viewed as limiting.

Referring back to FIG. 13, it should be appreciated that a recirculation line 1318 may also be utilized to recirculate the liquid in the container through a heater to maintain a pre-determined temperature in the container. A liquid pump 1320 may be used to pump the liquid 1310 in the container 1302 through a heater 1322 and back to the container 1302. It should be appreciated that the liquid pump could be utilized to pump water from either the top of the container or bottom. In the case where the liquid is removed from the top of the container and pumped back into the container through the cavity 1304 and the perforations 1308, additional massaging effects would be provided. It should be appreciated that any heater capable of heating a liquid flowing through a line, tube or pipe may be used. Moreover, heating of the liquid in the container may be accomplished in a variety of manners such as the application of an external heat source surrounding the container, the insertion of a heating element in the container, or the pumping of warm fluid into the container through the hydrotherapy device 1200 itself. Further, any control mechanism may be used to operate this recirculation line and maintain the temperature of the liquid in the container at the desired value. It should be appreciated that while FIG. 13 is discussed in terms of the use of a heater, it may be desirable to utilize cool or colder water as the fluid that is recirculated. In this case, the heater may be replaced with a device for cooling the liquid, such as a cold bath or a heat exchanger that utilizes a cooling fluid.

In each of the above described embodiments, the geometry of the hydrotherapy device, the hollow passage or channel and the perforations may vary. Circular geometry is preferred but is not a limitation on the present invention. Similarly the number of channels or hollow passages and perforations may vary.

As noted previously, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. Furthermore, the order of steps in the method described above and in the claims are not necessarily intended to occur in any particular sequence unless so described. It is intended that the scope of the invention be defined by the following claims and their equivalents.

What is claimed is:

1. A device for dispersing a fluid into a body of liquid, comprising:
a body having an outer surface that comprises a top surface and is configured to be disposed within a container for holding a liquid;
wherein said body defines a plurality of fluidly-connected and embedded channels, each fluidly connected to a separate perforation on said top surface, and an opening in said outer surface fluidly connected to at least one of said plurality of fluidly-connected and embedded channels and configured to receive and pass a fluid to said at least one of said plurality of fluidly-connected and embedded channels.

2. The device of claim 1, wherein said body is molded plastic.

3. The device of claim 1, wherein said body is a cylindrical body.

4. The device of claim 2, wherein said plurality of fluidly-connected embedded channels each extend in a radial direction from a center of said cylindrical body.

5. The device of claim 4, further comprising a plurality of perforations disposed along a length of, and fluidly connected to, each of said plurality of fluidly-connected and embedded channels.

6. The device of claim 1, further comprising a hose fluidly connected to said opening for passing the fluid to said at least one of said plurality of fluidly-connected and embedded channels.

7. The device of claim 1, wherein said body has a pre-determine shape that conforms to an inside contour of the container, thereby providing a friction-fit between said body and the container.

8. The device of claim 7, wherein said body is a cylindrical body having a circumference and further comprises a sealing gasket about said circumference that engages the inside wall of the container.

9. The device of claim 1, further comprising:
a container configured to receive said body; and
a hose fluidly connected to said opening for passing the fluid to said at least one of said plurality of fluidly-connected and embedded channels.

10. The device of claim 9, further comprising:
a recirculation line having a first end disposed in said container and a second end disposed in said container;
a pump connected to said recirculation line for pumping a liquid from said container through said recirculation line back to said container
a heater thermally connected to said recirculation line for heating the liquid.

11. A device for dispersing a fluid into a body of liquid, comprising:
a ring-shaped body having and outer surface comprising an inner side surface and configured to be disposed within a container for holding a liquid;
wherein said body defines an embedded, substantially circular channel, an opening in said outer surface fluidly connected to said embedded, approximately circular channel and configured to receive a fluid, and a plurality of perforations on said inner side surface fluidly connected to said embedded, approximately circular channel.

12. The device of claim 11, wherein said body is molded plastic.

13. The device of claim 11, further comprising a hose fluidly connected to said opening for passing the fluid to said at least one of said plurality of fluidly-connected and embedded channels.

14. The device of claim 11, wherein said ring-shaped body has a pre-determined outside diameter that conforms to an inside contour of the container, thereby providing a friction-fit between said body and the container.

15. The device of claim 14, further comprising a sealing gasket about a outer circumference of said ring-shaped body that engages the inside wall of the container.

16. The device of claim 11, further comprising:
a container configured to receive said ring-shaped body; and
a hose fluidly connected to said opening for passing the fluid to said embedded, approximately circular channel.

17. The device of claim 16, further comprising:
a recirculation line having a first end disposed in said container and a second end disposed in said container;
a pump connected to said recirculation line for pumping a liquid from said container through said recirculation line back to said container
a heater thermally connected to said recirculation line for heating the liquid.

18. A device for dispersing a fluid into a body of liquid, comprising:
a body having a substantially flat bottom base and an outer surface comprising a top surface that defines a depression in said body, said depression having a surrounding wall comprising an upper portion having an upper portion perimeter and a lower portion and configured for receipt of a container;
wherein said body defines a outer surface opening and wherein said upper portion is configured to seal against the container and said lower portion is configured to define, in conjunction with a portion of the container, a cavity fluidly connected to said outer surface opening for passing a fluid from said outer surface opening to said cavity.

19. The device of claim 18, wherein said body is molded plastic.

20. The device of claim 18, wherein said depression is a cylindrical hole.

21. The device of claim 20, wherein said cavity is a substantially semi-circular channel in said lower portion and extending around a circumference of said cylindrical hole.

22. The device of claim 18, wherein said depression has a shape of a frustrum of a right circular cone.

23. The device of claim 18, further comprising a hose fluidly connected to said opening for passing the fluid to said channel.

24. The device of claim 18, further comprising:
a container configured to fit into said depression and having a plurality of perforations adjacent said cavity; and
a hose fluidly connected to said opening for passing the fluid to said cavity.

25. The device of claim 24, further comprising:
a recirculation line having a first end disposed in said container and a second end disposed in said container;
a pump connected to said recirculation line for pumping a liquid from said container through said recirculation line back to said container
a heater thermally connected to said recirculation line for heating the liquid.

26. A method for massaging, comprising:
placing an injured bodily area within a liquid in a container;
pumping a fluid through a fluid dispersion body disposed within said container below said injured bodily area, wherein said fluid dispersion body has an outer surface that comprises a top surface and defines a plurality of fluidly-connected and embedded channels, each fluidly connected to a separate perforation on said top surface, and an opening in said outer surface fluidly connected to at least one of said plurality of fluidly-connected and embedded channels and configured to receive and pass said fluid to said at least one of said plurality of fluidly-connected and embedded channels.

27. The method of claim 26, further comprising:
recirculating said liquid through a heater to maintain a pre-determined temperature in said container.
